(19) United States
(12) Patent Application Publication
(10) Pub. No.: US 2015/0185582 A1
(43) Pub. Date: Jul. 2, 2015

(54) MASK DESIGN AND METHOD OF FABRICATING A MODE CONVERTER OPTICAL SEMICONDUCTOR DEVICE

(71) Applicant: Emcore Corporation, Albuquerque, NM (US)

(72) Inventors: Martin Kwakernaak, Los Angeles, CA (US); Xiaoguang He, Diamond Bar, CA (US)

(73) Assignee: Emcore Corporation, Albuquerque, NM (US)

(21) Appl. No.: 14/140,759

(22) Filed: Dec. 26, 2013

(51) Int. Cl. G02F 1/225; G02B 6/136; G02F 1/025

(52) U.S. Cl. CPC G02F 1/2257; G02F 1/025; G02B 6/136; G02B 2006/12176

(57) ABSTRACT

A method of fabricating waveguide on a semiconductor substrate including an optical input at a first end region for receiving a continuous wave coherent light beam having a predetermined first beam profile, and a second end region opposite the first end region active layer for transferring the light beam with a predetermined second beam profile, including forming a sequence of layers including a bottom cladding layer, an active layer, and a top cladding layer on a semiconductor substrate; providing an appropriately configured mask over the region where a waveguide is to be formed; etching the semiconductor substrate down to the active layer thereby forming a partial waveguide structure; and re-growing the top cladding layer and the contact layer to the uniformly planar level of the top surface of the partial waveguide structure.

### FIELD OF THE DISCLOSURE

The disclosure relates generally to the field of optical devices, and more particularly to method for fabricating a mode converter region in a semiconductor device, and the devices fabricated for performing optical beam spreading or narrowing in a waveguide.

### BACKGROUND OF THE DISCLOSURE

An optical telecommunication system transmits information from one place to another by way of an optical carrier whose frequency typically is in the visible or near-infrared region of the electromagnetic spectrum. A carrier with such a high frequency is sometimes referred to as an optical signal, an optical carrier, light beam, or a lightwave signal. The optical telecommunication system includes several optical fibers and each optical fiber includes multiple channels. A channel is a specified frequency band of an electromagnetic signal, and is sometimes referred to as a wavelength. The purpose for using multiple channels in the same optical fiber (called dense wavelength division multiplexing (DWDM)) is to take advantage of the unprecedented capacity (i.e., bandwidth) offered by optical fibers. Essentially, each channel has its own wavelength, and all wavelengths are separated enough to prevent overlap. The International Telecommunications Union (ITU) currently determines the channel separations.

One link of an optical telecommunication system typically has a transmitter, the optical fiber, and a receiver. The transmitter has a laser, and a modulator, which converts an information-containing electrical signal into the optical signal and launches it into the optical fiber. The optical fiber transports the optical signal to the receiver. The receiver converts the optical signal back into the information-containing electrical signal.

The present disclosure is directed to an external optical modulation for use in the transmitter of an optical telecommunications system. The optical modulator is a single semiconductor chip including a mode converter, an MMI coupler and a Mach-Zehnder modulator. Mode converters are semiconductor optical devices that in some implementations have a tapered structure for adiabatically changing the mode cross-sectional area or beam profile of the light beam which travels along a waveguide structure. In an optical modulator, mode converters can be used to couple an optical input (e.g. from a laser source) to a multimode interference (MMI) device or MMI coupler, with the output of the MMI coupler thereafter being coupled to the optical modulator.

Current commercially available optical modulators utilize mode converters or a mode conversion region of an integrated semiconductor device, which are fabricated by an etching/regrowth process. A sequence of epitaxy layers with n-cladding layer, active layer and a thin (about 0.2 um) p-cladding layer are grown. Then, the mode converter area is partially etched into the active layer about 0.26 um depth. After etching, the rest of p-cladding layer and contact layer are grown without a masking process. In the conventional method, since the mode converter section etching depth is about 0.5 um, the flatness of regrowth surface is around 0.5 um or less, the waveguide can be etched reasonably well.

The drawbacks or disadvantages of such mode converter designs are that most of the modulator surface area is covered by regrown p-clad and contact layers. There is a greater likelihood to have a growth defect associated with the regrowth process due to the anisotropic etching profiles beneath the edges of the mask when oriented in certain direction with respect to the crystal lattice planes of the semiconductor body. As a result, a large portion of the device is subject to growth defects. The regrowth interface also results in the performance degradation.

The mode converter, or mode conversion region of an integrated semiconductor device, is coupled to a multimode interference (MMI) device.

Multimode interference (MMI) devices, such as MMI couplers, are important integrated optical components for optical signal processing and routing. MMI devices typically utilize direct coupling in which the input waveguide is in contact with one or more output waveguides. This is in contrast to indirect coupling which relies upon evanescent field coupling through waveguides which are in close proximity to each other.

MMI devices may be used for beam splitting, combining and coupling and contain one or more input waveguides and one more output waveguides. Input and output waveguides are connected to a central multimode waveguide region. An MMI device of particular interest consists of one input waveguide and two or more output waveguides. The physical characteristics of the coupling and multimode waveguide regions are selected such that modal dispersion within the central multimode waveguide region provides for a single beam of light input into the first coupling waveguide to be split into the two or more second coupling waveguides. Operated in reverse, the device may function as a beam combiner, and may be positioned downstream of the optical modulator to couple to the mode converter, and optical output

For instance, the optoelectronic device may be suitable for optical signal transmission and reception at a variety of per-second data rates, including, but not limited to, 10 G, 25 G, 40 G, 100 G, or higher data rates. Furthermore, the principles of embodiments of the invention can be implemented in optoelectronic devices configured for shortwave or long wave optical transmission and having any form factor such as XFP, SFP, SFP+ and CFP, without restriction.

### SUMMARY OF THE INVENTION

### Objects of the Invention

It is an object of the present disclosure to provide a method for making a mode converter integrated into a semiconductor modulator device.

It is another object of the present disclosure to provide mask for fabricating the mode converter region in a semiconductor modulator device.

It is an object of the present disclosure to provide a method for fabricating a waveguide in a semiconductor device that changes the beam profile.

It is another object of the present disclosure to provide a means to substantially reduce misalignment errors in coupling a semiconductor laser to a semiconductor modulator.

It is an object of the present disclosure to provide a method for improving the planarity of a regrowth process in a semiconductor device in which a mask has been used to etch away a portion of the semiconductors body.

It is another object of the present disclosure to provide a means to substantially reduce coupling loss in a semiconductor modulator.

Some implementations of the present disclosure may incorporate or implement fewer of the aspects and features noted in the foregoing objects.

### Features of the Disclosure

Briefly, and in general terms, the present disclosure provides a method of fabricating an optical modulator including a semiconductor device having an optical input at a first end region for receiving a continuous wave coherent light beam having a predetermined beam profile, and a second end region opposite the first end region, a waveguide layer for transferring the light beam, an electrode connected to a radio frequency signal input and a bias potential for creating an electric field in the waveguide and optically modulating the light beam as the beam traverses the waveguide, and an optical output connected to the waveguide at the second end region for transferring the modulated light beam, comprising: forming a sequence of layers including a bottom cladding layer, an active layer, a top cladding layer and a contact layer on a semiconductor substrate; providing a mask over the region where a mode conversion region is to be formed; etching the semiconductor body down into a small portion of the thickness of the active layer thereby forming a mesa structure over the active region wherein the etching technique anisotropically etches along a plane depending upon the direction of the edge of the mask with respect to the crystal direction of the semiconductor body; re-growing the portion of the active layer, the top cladding layer and the contact layer to the uniformly planar level of the top surface of the mesa in the mode conversion region; and forming a waveguide in the mode conversion region by etching the semiconductor substrate down to the active layer, forming a waveguide structure that spreads the beam intensity of the predetermined beam profile.

In another aspect, the present disclosure provides a method of fabricating a waveguide interface on a semiconductor substrate including an optical input at a first active layer at a first region of the substrate for receiving a continuous wave coherent light beam having a predetermined first beam profile, and a second active layer at a second region of the substrate directly adjacent to the first region active layer for transferring the light beam with a predetermined second beam profile different from the first beam profile, comprising: forming a sequence of layers including a bottom cladding layer, an active layer, a top cladding layer and a contact layer on a semiconductor substrate; providing a mask over the region where a waveguide interface is to be formed, the mask having a peripheral profile so that during subsequent etching and regrowth of the contact layer and cladding layer, the different etching profiles of such layers as a function of the crystalline structure of the layers with respect to the direction of the waveguide on both sides of the waveguide interface is compensated by the configuration of the peripheral end region of the mask; etching the semiconductor substrate down to the active layer thereby forming a partial waveguide interface structure from the first active layer to the second active layer; removing the mask; re-growing the top cladding layer and the contact layer to the level of the top surface of the partial waveguide structure; and etching the semiconductor substrate down to the active layer from the first end region to the second end region, thereby forming a waveguide interface from the first active layer to the second active layer.

In another aspect, the present disclosure provides a method of fabricating a waveguide on a semiconductor substrate including an optical input at a first end region for receiving a continuous wave coherent light beam having a predetermined first beam profile, and a second end region opposite the first end region active layer for transferring the light beam with a predetermined first beam profile, comprising: forming a sequence of layers including a bottom cladding layer, an active layer, a top cladding layer and a contact layer on a semiconductor substrate; forming a first multimode interference (MMI) device having a first end optically coupled to an input waveguide, the first MMI device configured to receive a first optical signal and split the first optical signal into a second and third optical signals each having a respective power level and supplying said second optical signal to a first output waveguide and supplying said third optical signal to a second output waveguide, said MMI device having a propagation axis at an acute angle to a propagation axis of said input waveguide; forming a Mach-Zehnder modulator including a first modulator arm coupled to the first output waveguide to receive the second optical signal; and a second modulator arm coupled to the second output waveguide to receive the third optical signal; forming a second MMI device having a first input coupled to said first modulator arm and a second input coupled to said second modulator arm, said second MMI device configured to combine the second and third optical signals destructively or constructively based on a refractive index change in at least one of the modulator arms and output a modulated optical signal to an output waveguide of the second MMI device.

In another aspect, the mask has a peripheral shape so that in the semiconductor region where the mode conversion region is to be formed, the process of re-growing the top cladding layer and the contact layer to the level of the top surface of the partial waveguide structure results in a relatively planar top surface.

In another aspect, the mask has a generally parallelogram peripheral shape, including a first and second wing-shaped projections extending at a first end portion of the parallelogram along the longer opposed sides of the parallelogram, each wing-shaped projection having an elongated first side extending substantially parallel to the longer side of the parallelogram, the first wing-shaped projection having a second side extending orthogonally to the first side along the first end portion of the parallelogram, and a third side extending at an obtuse angle to the first side along the first end position of the parallelogram; the second wing-shaped projection having a second side extending orthogonally to the first side along the first end position of the parallelogram, a second side extending at an acute angle to the first side along the first end position of the parallelogram, and a third side extending at an obtuse angle to the first side along the first end position of the parallelogram; and the mask has a third and fourth wing-shaped projections extending at a second end portion of the parallelogram along the longer opposed sides of the parallelogram.

In some embodiments, the mask is generally a parallelogram in shape, having a first and second wing-shaped projections extending at a first end portion of the parallelogram along the longer opposed sides of the parallelogram.

In some embodiments, the first and second wing-shaped projections are different in shape.

In some embodiments, the wing-shaped projections have an elongated first side extending substantially parallel to the longer side of the parallelogram.

In some embodiments, the first wing-shaped projection has a second side extending orthogonally to the first side along the first end portion of the parallelogram.

In some embodiments, the first wing-shaped projection has a third side extending at an obtuse angle to the first side along the first end position of the parallelogram.

In some embodiments, the second wing-shaped projection has a second side extending orthogonally to the first side along the first end position of the parallelogram.

In some embodiments, the second wing-shaped projection has a second side extending at an acute angle to the first side along the first end position of the parallelogram.

In some embodiments, the second wing-shaped projection has a third side extending at an obtuse angle to the first side along the first end position of the parallelogram.

In some embodiments, the mask has a third and fourth wing-shaped projections extending at a second end portion of the parallelogram along the longer opposed sides of the parallelogram.

In some embodiments, the third and fourth wing-shaped projections are different in shape.

In some embodiments, the first and third wing-shaped projections are at diagonally opposite corners of the parallelograms and are mirror images of one another.

In some embodiments, the second and fourth wing-shaped projections are at diagonally opposite corners of the parallelograms and are mirror images of one another.

In some embodiments, the first wing-shaped projection has a second side extending orthogonally to the first side along the first end portion of the parallelogram, and a third side extending at an obtuse angle to the first side along the first end position of the parallelogram; the second wing-shaped projection has a second side extending orthogonally to the first side along the first end position of the parallelogram, a second side extending at an acute angle to the first side along the first end position of the parallelogram, and a third side extending at an obtuse angle to the first side along the first end position of the parallelogram; and the mask has a third and fourth wing-shaped projections extending at a second end portion of the parallelogram along the longer opposed sides of the parallelogram.

In another aspect, the present application includes an integrated semiconductor device in which a mode conversion region is coupled to a multimode interference coupling region. The multimode interference coupling region or coupler may include a first waveguide defined by a first portion having a first propagation axis. The coupler may include a multimode interference (MMI) portion positioned at an acute angle to said first propagation axis and having a first end optically coupled to the first waveguide. The MMI portion may split the first optical signal into second and third optical signals each having a different power level according to a power ratio functionally associated with a magnitude of the acute angle. Second and third waveguides may be optically coupled to a second end of the MMI portion and may be arranged to receive the second and third optical signals.

In another aspect, the present application includes an integrated semiconductor device in which a mode conversion region is coupled to a Mach-Zehnder modulator. The modulator may include a first multimode interference (MMI) device having a first end optically coupled to an input waveguide. The first MMI device may be configured to receive a first optical signal and split the first optical signal into a second and third optical signals each having a respective power level and supplying said second optical signal to a first output waveguide and supplying said third optical signal to a second output waveguide. The MMI device may have a propagation axis at an acute angle to a propagation axis of said input waveguide. A first modulator arm may be coupled to the first output waveguide to receive the second optical signal. A second modulator arm may be coupled to the second output waveguide to receive the third optical signal. First and second electrodes may be coupled to the corresponding first and second modulator arms, each of the electrodes may be configured to change a refractive index in the modulator arms in response to an applied electric field. A second MMI device may have a first input coupled to said first modulator arm and a second input coupled to said second modulator arm. The second MMI device may be configured to combine the second and third optical signals destructively or constructively based on a refractive index change in at least one of the modulator arms and output a modulated optical signal to an output waveguide of the second MMI device.

In another aspect, the present application is very generally directed to the solution of a variety of processing problems associated with etching regions in a semiconductor body having specific lattice planes in which the etching technique is sensitive to the lattice structures, so that when a mask is used to define an etched boundary, the resulting profile of the etched region is affected by the position and orientation of the mask with respect to the lattice planes, and in particular an effect where the etching does not produce a vertical structure defined by the mask boundary. One of the processing problems associated with such a situation is that when regrowth of the semiconductor region which has been etched out is subsequently performed, the resulting surface of the regrown region will not be configured and shaped as it was originally, but may be non-planar and/or have overgrowth or overhang regions. Such semiconductor regions or surfaces may affect the performance of the implemented semiconductor device, or change the operational parameters from point to point on the surface in a manner that is not desired or readily predictable.

In that regard, the “solution” of the identified processing problems is the definition of a mask design having a set of edges constituting the periphery of the mask to compensate or correct for the mismatch between etching rates and the desired boundaries of the etched region. More particularly, the present disclosure will illustrate by example the design of a mask (or more specifically, the “mask profile” or the sequence of edges defining the boundary of the mask in the form of edge “vectors” or lines of a given length and direction) for use in a process in which defined regions of an electro-optical semiconductor device are etched out and then regrown after further process steps. Having a knowledge of the regrowth areas which are affected by the mask boundaries, and using the principles taught by the present disclosure, the designer will be able to define a suitable mask profile to provide a uniformly planarized surface (or other topographical or structural characteristic) to meet the required device design parameters.

Intermediate generalization of the above design issues, goals and solutions are also within the scope of the present disclosure, such as in the context of etching or material removal processes in which the resulting semiconductor structures deviate from the ideal shapes defined by a mask or other design blueprint, and the etch (or material removal) is adversely affected by the different etch profiles or etch rates depending how the lattice planes are oriented with respect to the defined masking or etching boundaries.

The present invention is not limited to the above features and advantages. Some implementations or embodiments may incorporate or implement fewer of the aspects or features noted in the foregoing summaries. Those skilled in the art will recognize additional features and advantages upon reading the following detailed description, and upon viewing the accompanying drawings.

### BRIEF DESCRIPTION OF THE DRAWINGS

The invention will be better and more fully appreciated by reference to the following detailed description when considered in conjunction with the accompanying drawings, wherein:

FIG. 1 is an isometric view of an exemplary optical modulator in accordance with the disclosure;

FIG. 2 is a cross-sectional view of the semiconductor structure through the 2A-2A plane depicted in FIG. 1;

FIG. 3A is a top plan view of a semiconductor wafer on which a number of modulators are implemented;

FIG. 3B is an enlarged view of a single modulator chip with a mask in a first configuration positioned over the MMI and modulator regions of the chip;

FIG. 3C is a top plan view of a semiconductor wafer with the masks of FIG. 3B;

FIG. 3D is an enlarged view of a single modulator chip with a mask in a second configuration positioned over the MMI and modulator regions of the chip;

FIG. 3E is a top plan view of a semiconductor wafer with the mask of FIG. 3D;

FIG. 4A is a highly simplified perspective view of the mask and semiconductor chip of FIG. 3D;

FIG. 4B is a perspective view of the semiconductor structure of FIG. 5A after etching down through a portion of the active layer;

FIG. 5A is a cross-sectional view of the semiconductor structure of the modulator chip through the 5A-5A plane depicted in FIG. 4B;

FIG. 5B is a cross-sectional view of the semiconductor structure of the modulator chip through the 5B-5B plane depicted in FIG. 4B;

FIG. 5C is a cross-sectional view of the semiconductor structure of the modulator chip through the 5A-5A plane depicted in FIG. 4B after removal of the mask;

FIG. 5D is a cross-sectional view of the semiconductor structure of the modulator chip through the 5B-5B plane depicted in FIG. 4B after removal of the mask;

FIG. 5E is a cross-sectional view of the semiconductor structure of the modulator chip through the 5A-5A plane depicted in FIG. 4B after regrowth of the etched region;

FIG. 5F is a cross-sectional view of the semiconductor structure of the modulator chip through the 5B-5B plane depicted in FIG. 4B after regrowth of the etched region;

FIG. 6 is an enlarged view of a single modulator chip with a mask in a third configuration positioned over the MMI and modulator regions of the chip;

FIG. 7A is a cross-sectional view of the semiconductor structure of the modulator chip through the 7A-7A plane depicted in FIG. 6 after regrowth of the etched region;

FIG. 7B is a cross-sectional view of the semiconductor structure of the modulator chip through the 7B-7B plane depicted in FIG. 6 after regrowth of the etched region;

FIG. 8 is a simplified cross-sectional view of the semiconductor structure of FIG. 2A;

FIG. 9 is a simplified cross-sectional view of the semiconductor structure of FIG. 8 after etching a waveguide down to the active layer;

FIG. 10 depicts a semiconductor laser disposed closely adjacent to the modulator of FIG. 1;

FIG. 11A is a graph of the light beam intensity in the waveguide plotted against the height or y-dimension of the waveguide through the 11A-11A plane depicted in FIG. 10;

FIG. 11B is a graph of the light beam intensity in the waveguide plotted against the height or y-dimension of the waveguide through the 11B-11B plane depicted in FIG. 10;

FIG. 12A is a perspective view of a portion of the mode converter region showing the waveguide after the regrowth process using a mask such as depicted in FIG. 3B;

FIG. 12B is a perspective view of a portion of the mode converter region showing the waveguide after the regrowth process using a mask such as depicted in FIGS. 6; and

FIG. 13 is a graph depicting the improvement in performance of a modulator coupled to a laser as measured in the coupling loss in dB as a function of the misalignment between the two abutting waveguides, as measured in microns.

### DETAILED DESCRIPTION OF AN ILLUSTRATED EMBODIMENT

Details of the present disclosure will now be described, including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of actual embodiments nor the relative dimensions of the depicted elements, and are not drawn to scale.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

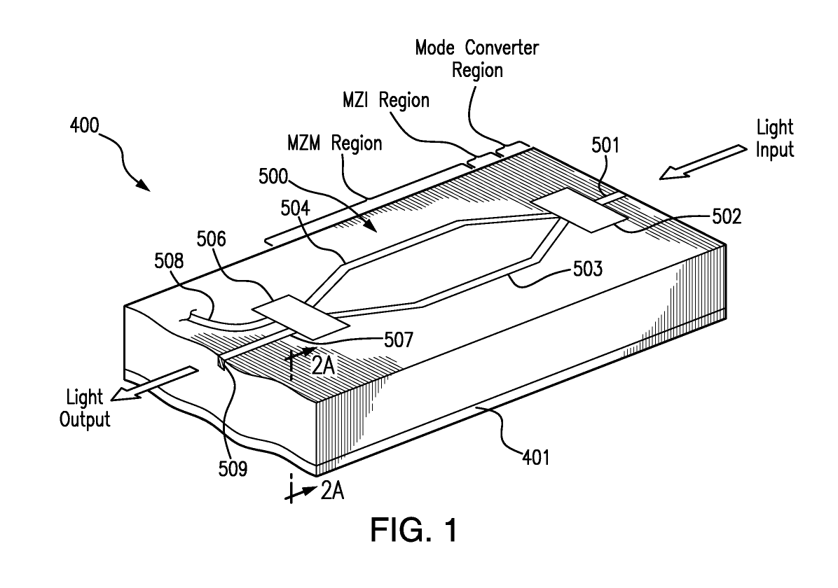

FIG. 1 is an isometric view of an exemplary optical modulator in accordance with the disclosure. The light from an external laser (not shown) is input to a waveguide 501 on the right hand side of the semiconductor device 400, which incorporates a mode converter fabricated in accordance with the present disclosure. The waveguide 501 is coupled to an MMI coupler 502. The MMI coupler 502 is coupled to the two arms 503, 504 of a Mach-Zehnder modulator 500 disposed along the central region of the device 400. The two arms 503, 504 are thereafter coupled to another MMI coupler 506, the coupler 506 having a first output coupled in turn to an output waveguide 509, with the second output of the MMI coupler 506 terminating on the device 400.

The crystal structure of the semiconductor body should be noted. Miller indices are usually used to identify the crystal planes, in which the crystal structure is represented by a truncated cube with the (001) plane at the top. In the case of a InP or GaAs compound semiconductor, which is the material of interest in the embodiments of the present disclosure, the crystal structure is known as the zinc blende structure, which represents a combination of two face centered cubic sub-lattices. In order to achieve suitable waveguide structures the the orientation shown in the Figure, the crystal planes of the semiconductor body are typically those as set forth in the drawing. In the typical embodiment of an indium phosphide semiconductor body, these orientations correspond to xxxxx. These specific crystal orientations will be assumed for all subsequent figures in the disclosure, although in other embodiments different semiconductor materials with different crystal orientations may be employed for other device applications and configurations, and the teachings of the present disclosure may be utilized in defining the mask configurations for such device structures.

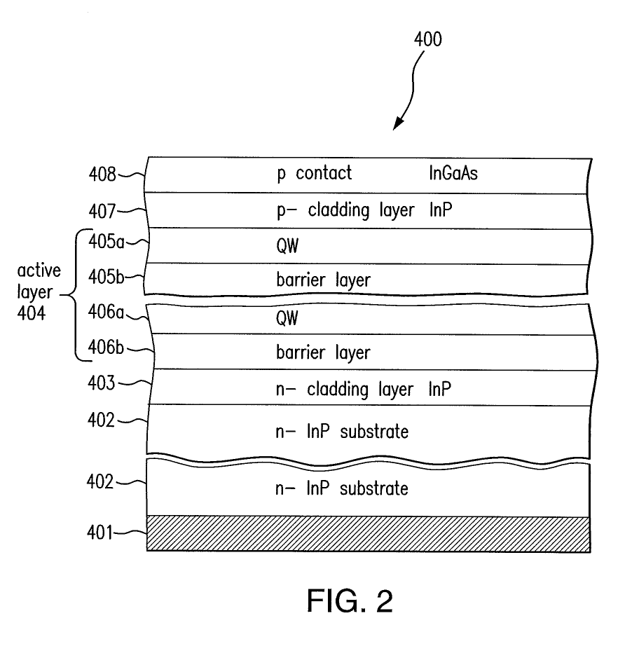

FIG. 2 is a cross-sectional view of the semiconductor structure of FIG. 1. The structure includes a n− substrate 402, which in one embodiment is composed of InP. A metal back contact layer 401 is applied to the substrate 402. On the top surface of the substrate 402 several epitaxial layers are grown, including a n− cladding layer 403, a active layer 404 comprising a plurality of pairs of quantum well layers 405a and barrier layers 405b. The Figure shows only two such pairs 405a/405b and 406a/406b for simplicity of the drawing. On top of the active layer 404 is a p− cladding layer 407, and a p contact layer 408. In one embodiment the cladding layers 403 and 407 are compose of InP, and the contact layer is composed in InGaAs.

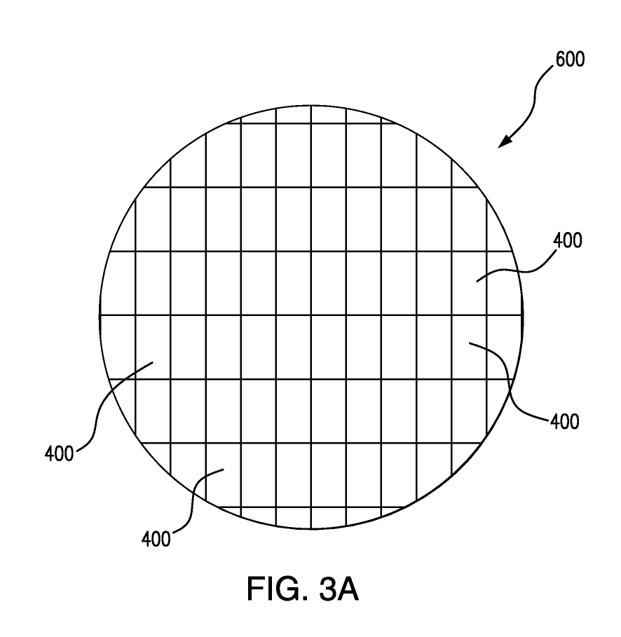

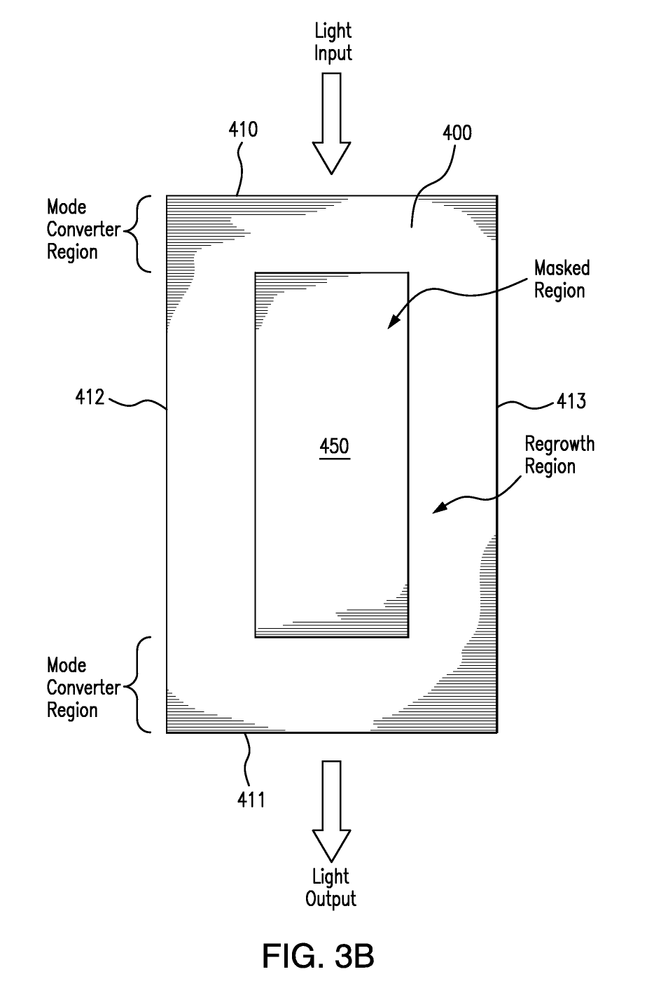

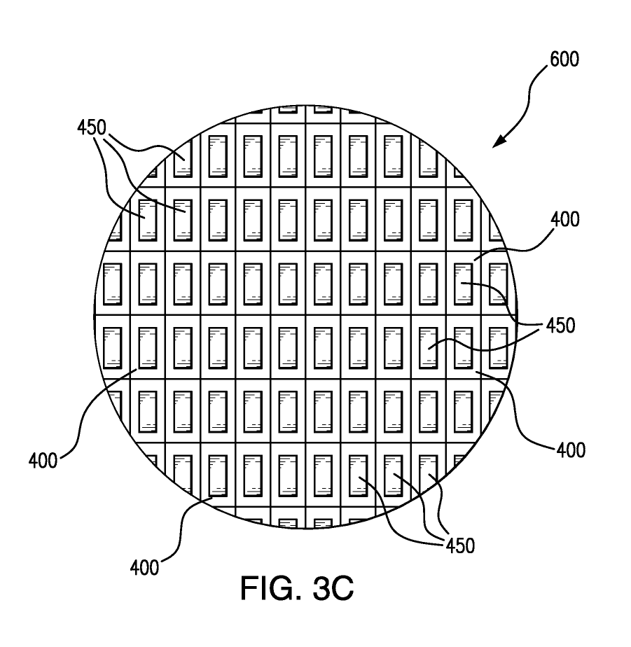

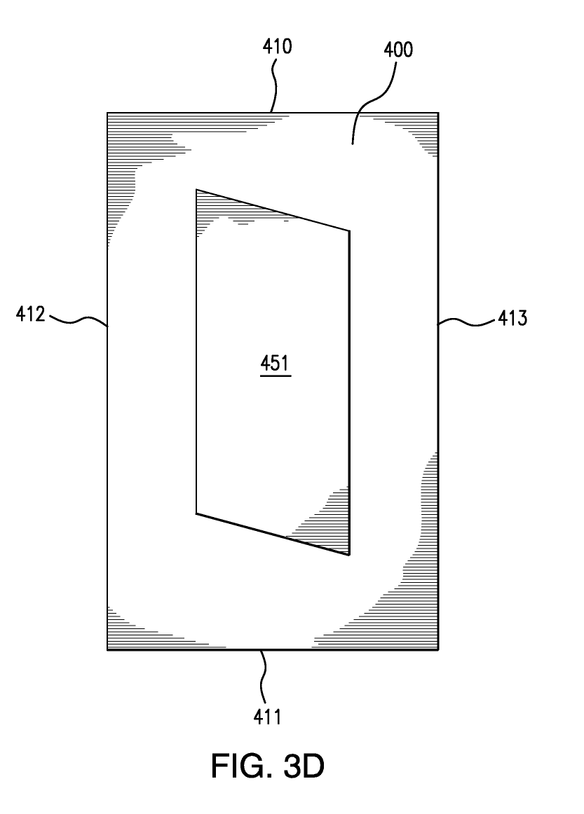

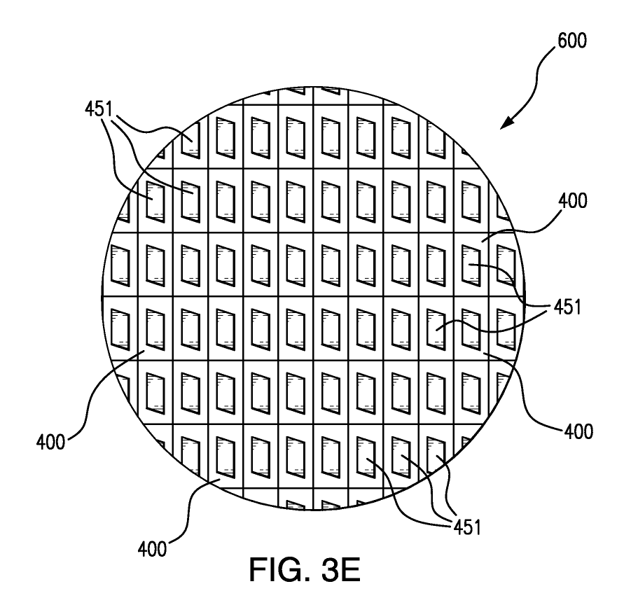

FIG. 3A is a top plan view of a semiconductor wafer 600 on which a number of modulators 400 are implemented.

FIG. 3B is an enlarged view of a single modulator chip 400 with a masked region 450 in a first configuration (or shape of the peripheral boundary of the mask) positioned over the MMI and modulator regions of the chip 400. The light from an external laser (not shown) will be input to a waveguide (not shown, since it is not yet fabricated at this stage) on the upper shorter edge 410 of the semiconductor device 400, which incorporates a mode converter to be fabricated in accordance with the present disclosure. The light from the center portion of the chip 400 is input to a waveguide (not shown, since it is not yet fabricated at this stage) on the lower shorter edge 411 of the semiconductor device 400, which incorporates a mode converter to be fabricated in accordance with the present disclosure. The regions between the two longer sides 412, 413 and the two shorter sides 410, 411 to the masked region 450 are to be etched to and slightly into the active layer 404, and subsequently epitaxially regrown to the top surface of the masked region 450, as will be subsequently illustrated and described.

FIG. 3C is a top plan view of a semiconductor wafer 600 with the masks 450 of FIG. 3B.

FIG. 3D is an enlarged view of a single modulator chip 400 with a mask 451 in a second configuration, now in the form of a parallelogram, positioned over the MMI and modulator regions of the chip.

FIG. 3E is a top plan view of a semiconductor wafer 600 with the masks 451 of FIG. 3D.

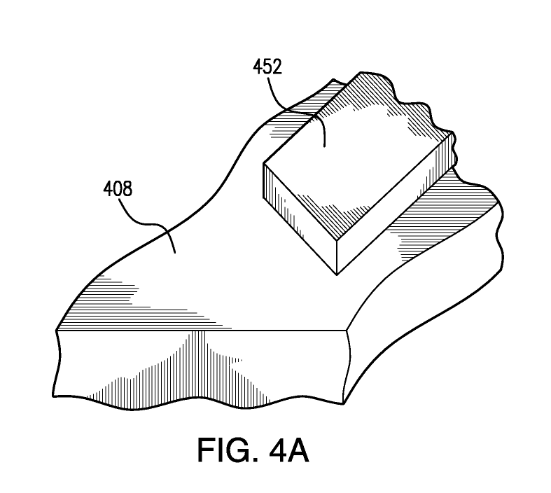

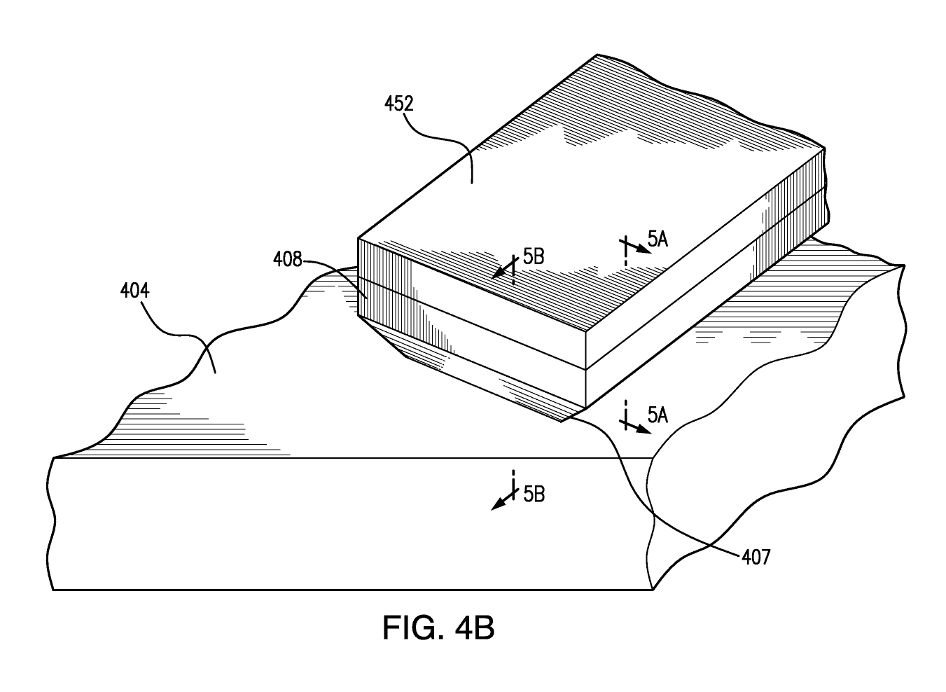

FIG. 4A is a highly simplified perspective view of the mask 451 of FIG. 3D disposed over the contact layer 408 of the semiconductor chip 400.

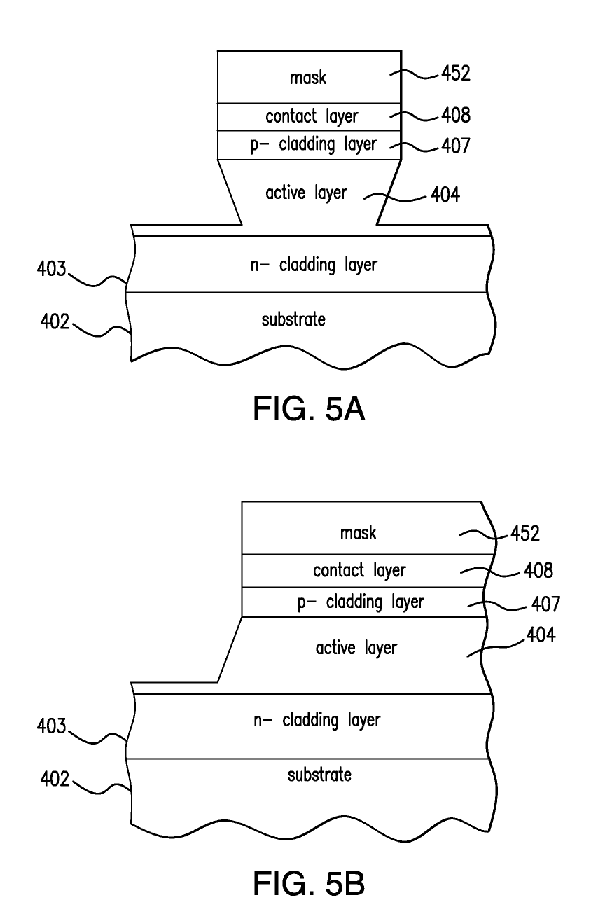

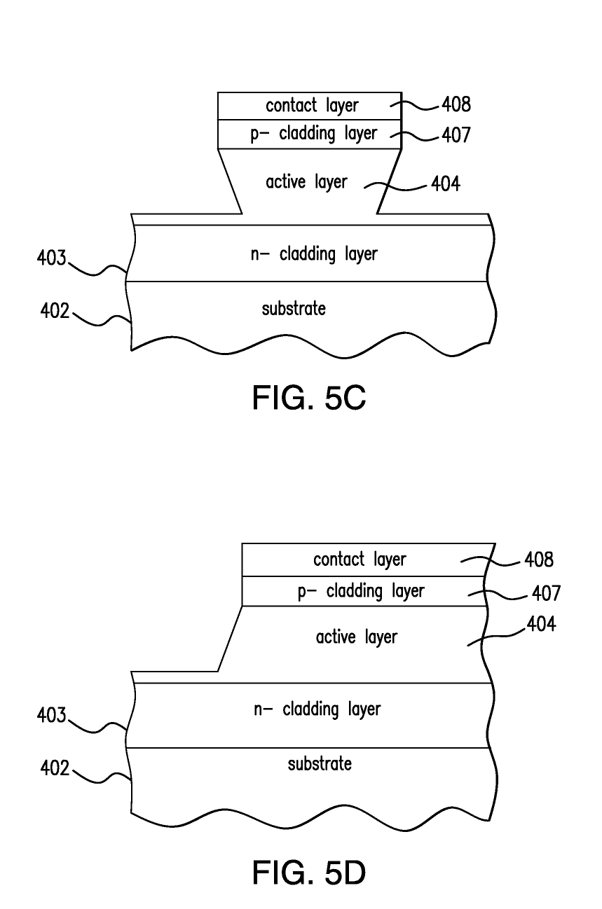

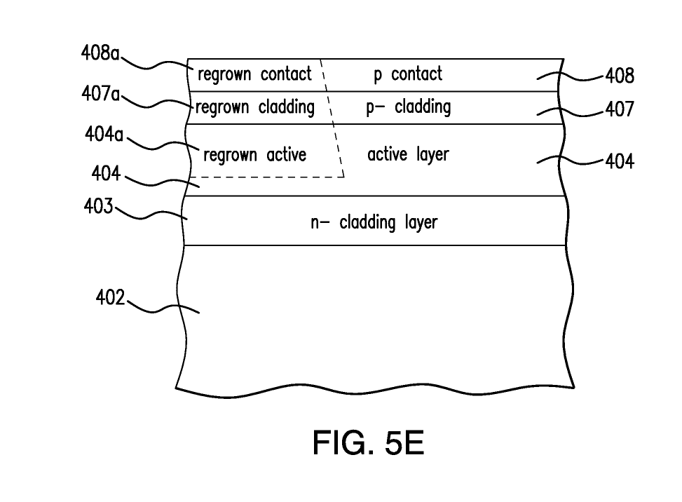

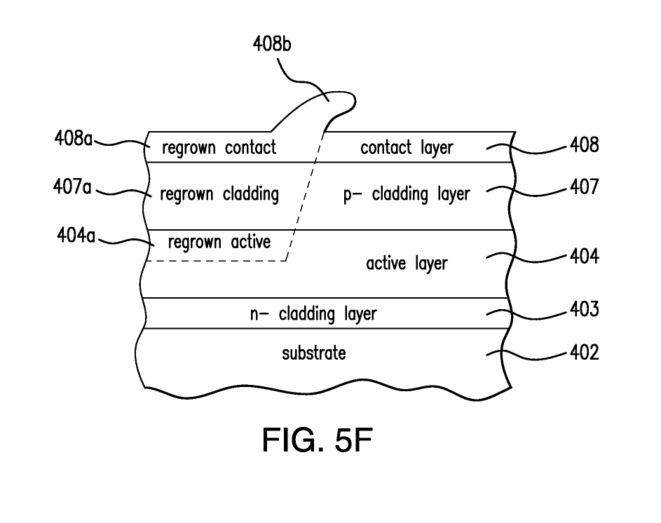

FIG. 4B is a perspective view of the semiconductor structure of FIG. 5A after etching down through a portion of the active layer 404, in some embodiments between 20% and 70% of the thickness of the active layer 404. In one embodiment, the thickness of the active layer is 0.4 microns, and 0.28 microns are etched.

The cross-section through the orthogonal planes 5A-5A and 5B-5B will be subsequently illustrated in FIGS. 5A and 5B to more accurately depict the result of the etching along the edges of the mask 451.

FIG. 5A is a cross-sectional view of the semiconductor structure of the modulator chip 400 through the 5A-5A plane depicted in FIG. 4B.

FIG. 5B is a cross-sectional view of the semiconductor structure of the modulator chip 400 through the 5B-5B plane depicted in FIG. 4B.

FIG. 5C is a cross-sectional view of the semiconductor structure of the modulator chip 400 through the 5A-5A plane depicted in FIG. 4B after removal of the mask 451.

FIG. 5D is a cross-sectional view of the semiconductor structure of the modulator chip 400 through the 5B-5B plane depicted in FIG. 4B after removal of the mask 451.

FIG. 5E is a cross-sectional view of the semiconductor structure of the modulator chip 400 through the 5A-5A plane depicted in FIG. 4B after regrowth of the etched region.

FIG. 5F is a cross-sectional view of the semiconductor structure of the modulator chip 400 through the 5B-5B plane depicted in FIG. 4B after regrowth of the etched region. In particular it is seen that there is an overgrowth region 408b that extends over the original planar surface of the contact layer 408.

The disadvantage of the overgrowth region 408b is that defects are more likely to occur in the underlying semiconductor material because of the surface quality. Such defects will adversely affect device performance.

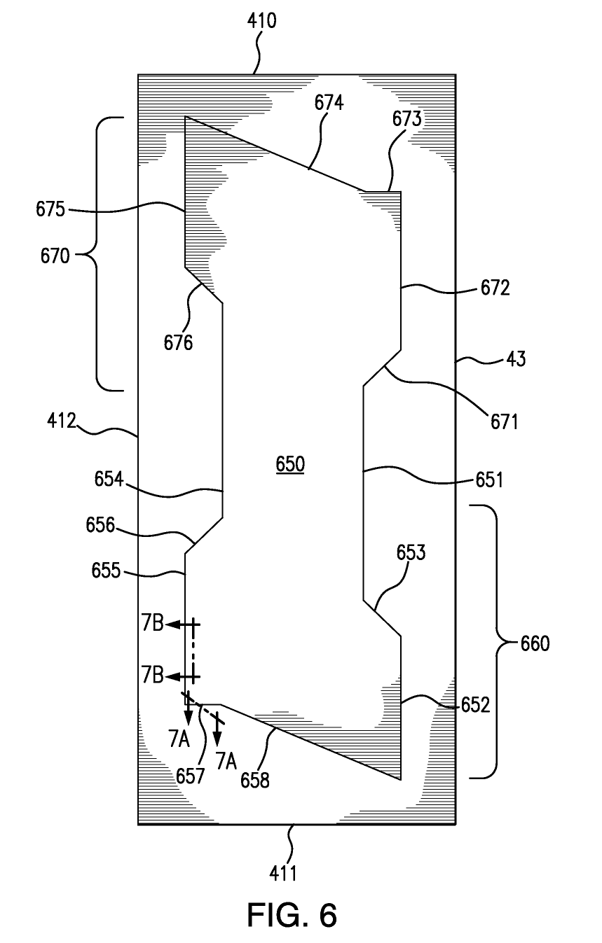

FIG. 6 is an enlarged view of a single modulator chip with a mask in a third configuration positioned over the MMI and modulator regions of the chip.

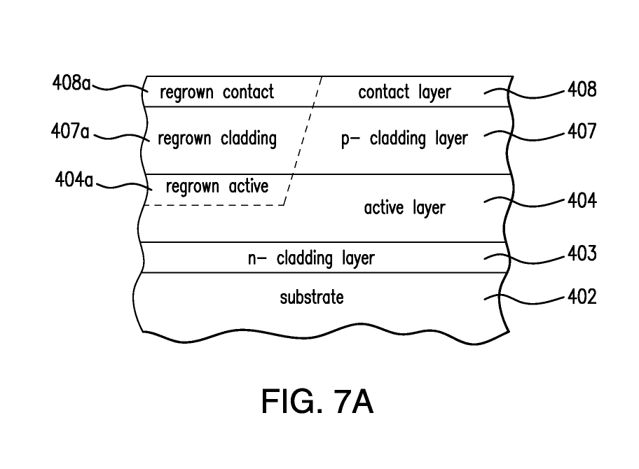

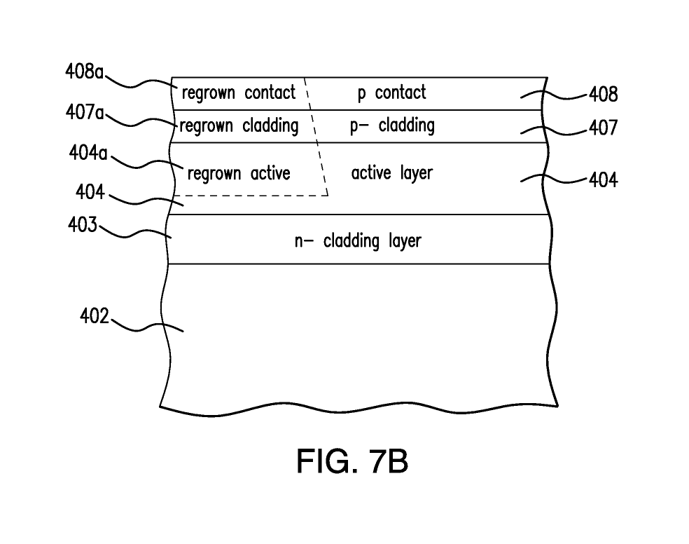

FIG. 7A is a cross-sectional view of the semiconductor structure of the modulator chip through the 7A-7A plane depicted in FIG. 6 after regrowth of the etched region.

FIG. 7B is a cross-sectional view of the semiconductor structure of the modulator chip through the 7B-7B plane depicted in FIG. 6 after regrowth of the etched region.

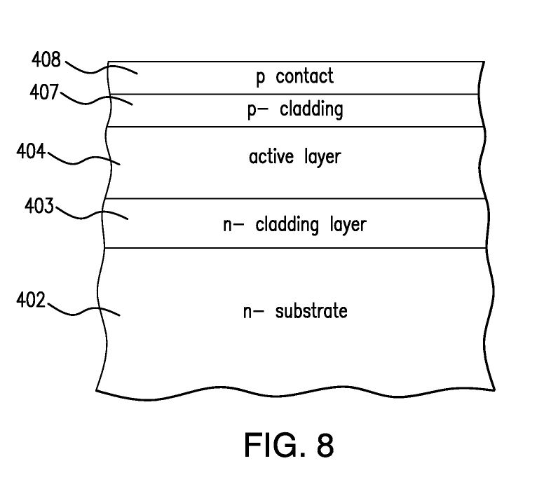

FIG. 8 is a simplified cross-sectional view of the semiconductor structure of FIG. 2A.

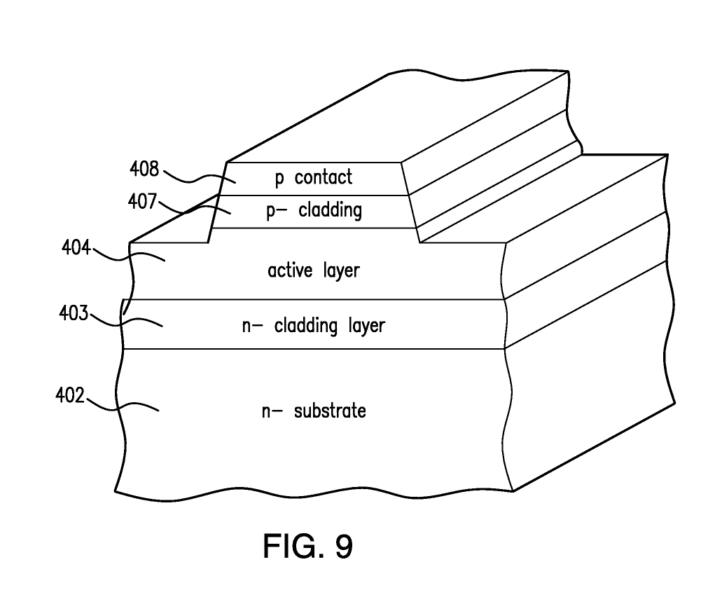

FIG. 9 is a simplified cross-sectional view of the semiconductor structures of FIG. 8 after etching a waveguide down into the active layer by an amount from 20% to 70% of the thickness of the active layer. In some embodiments, the thickness of the active layer is between 0.3 and 0.5 microns, and between 0.20 and 0.30 microns are etched.

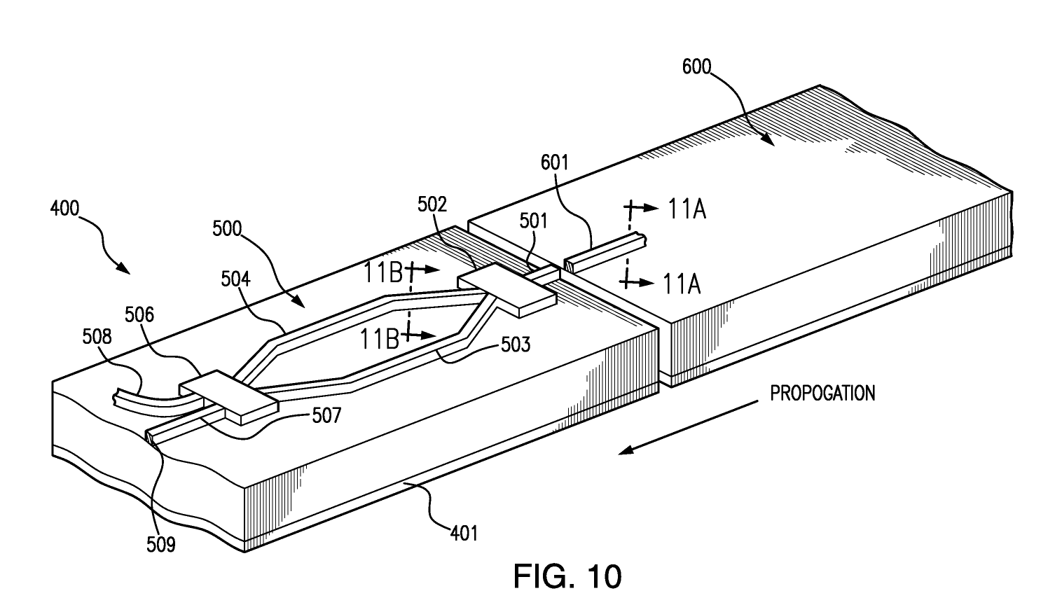

FIG. 10 depicts a semiconductor laser 600 disposed closely adjacent to the modulator 500 of the present disclosure. The structural details of the semiconductor laser 600 need not be described here, but generally, a DFB laser includes a positively or negatively doped bottom layer or substrate, and a top layer that is oppositely doped with respect to the bottom layer. An active region, bounded by confinement regions, is included at the junction of the two layers. These structures together form the laser body. A coherent stream of light that is produced in the active region of the DFB laser is emitted through a waveguide 601 at either longitudinal end, or facet, of the laser body. One facet is typically coated with a high reflective material that redirects photons produced in the active region toward the other facet to maximize the emission of coherent light from that facet end. A grating is included in either the top or bottom layer to assist in producing a coherent photon beam. DFB lasers are typically known as single mode devices as they produce light signals at one of several distinct wavelengths, such as 1,310 nanometers (“nm”) or 1,550 nm. Such light signals are appropriate for use in transmitting information over great distances via an optical communications network. The output from the DFB laser may be coupled to an optical element, such as a lens (represented by element 510), which focuses the beam from waveguide 601 into the waveguide 501 of the modulator 500.

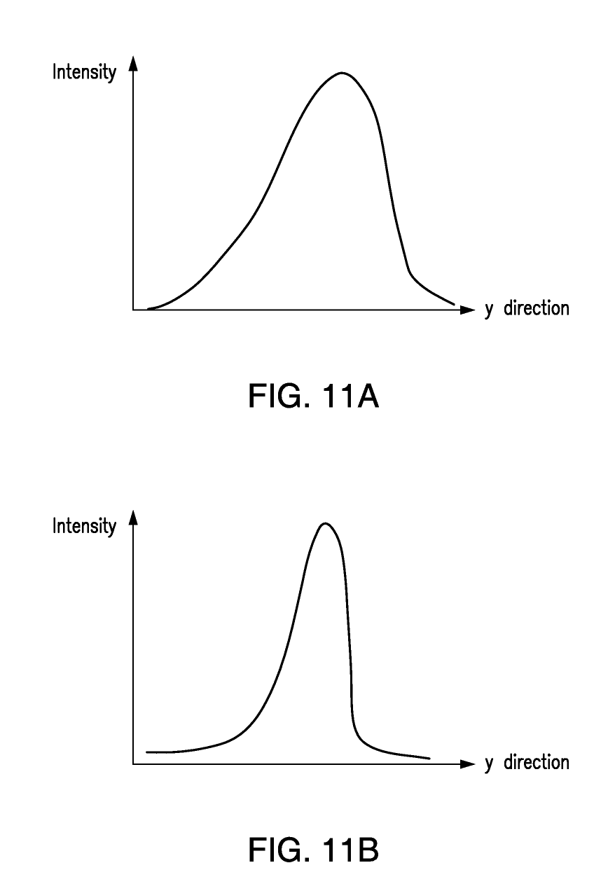

FIG. 11A is a graph of the light beam intensity of the output of the semiconductor laser 600 in the waveguide 601 plotted against the height or y-dimension of the waveguide through the 11A-11A plane depicted in FIG. 10. This is the light beam intensity at the input of the mode converter region 501 of the semiconductor device 500.

FIG. 11B is a graph of the light beam intensity in the waveguide plotted against the height or y-dimension of the waveguide through the 11B-11B plane depicted in FIG. 10.

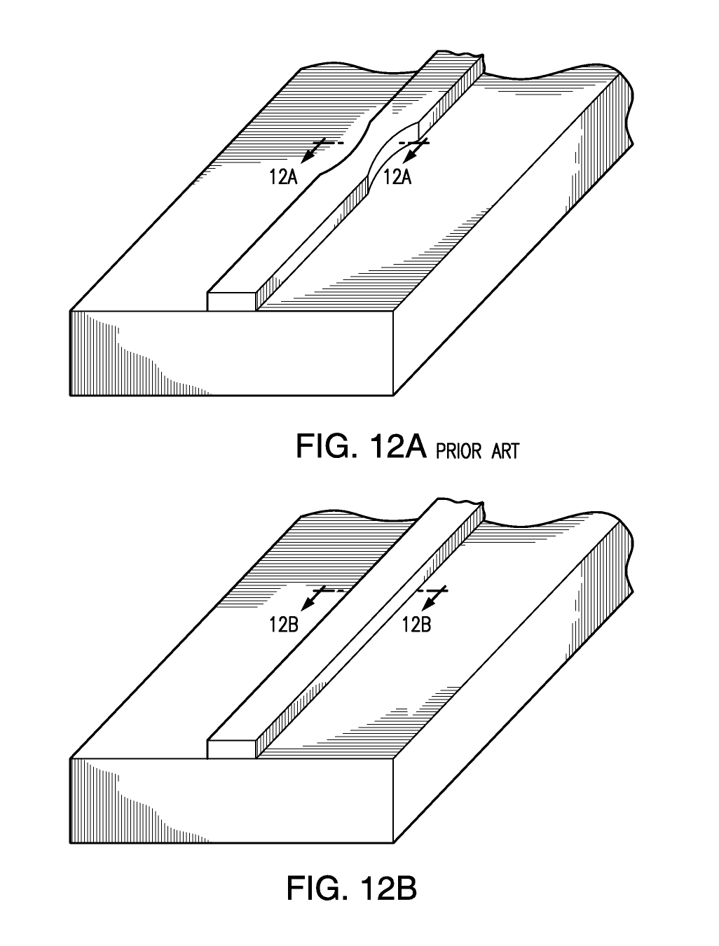

FIG. 12A is a perspective view of a portion of the mode converter region showing the waveguide after the regrowth process using a mask such as depicted in FIG. 3B. The narrow neck region at the interface between one portion of the mode conversion region and another will adversely affect the beam intensity being transmitted through the region, thereby reducing device performance.

FIG. 12B is a perspective view of a portion of the mode converter region showing the waveguide after the regrowth process using a mask such as depicted in FIG. 6. The point here is that the width of the waveguide is relatively uniform in the region at the interface between one portion of the mode conversion region and another, and therefore utilizing a mask such as depicted in FIG. 6 provides better device performance.

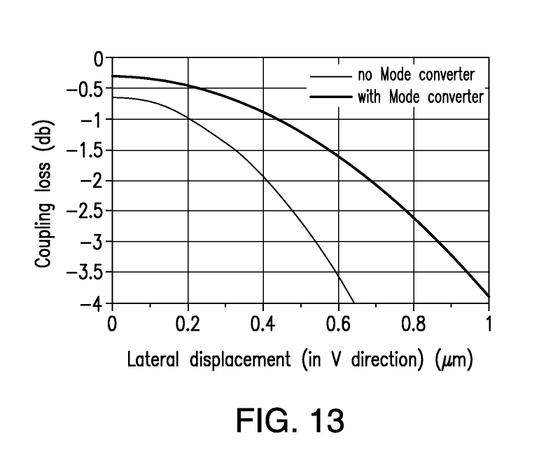

FIG. 13 is a graph depicting a simulation of the improvement in performance of a modulator coupled to a laser as measured in the coupling loss in dB as a function of the misalignment between the two abutting waveguides, as measured in microns. As previously noted, one of the concerns in high volume manufacturing of integrated optical devices such as laser/modulator devices is the issue of misalignment at the coupling interface between one chip and another, such as between a laser and a modulator. Since some degree of misalignment (or lateral displacement, as noted on one axis of the Figure) will always occur as part of a manufacturing process, the goal is to minimize the coupling loss. The graph indicates the substantially smaller coupling loss with the use of a mode converter, and more particularly the sensitivity of increased loss with larger amounts of misalignment or lateral displacement.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

The foregoing described embodiments depict different components contained within, or connected with, different other components. It is to be understood that such depicted arrangements or architectures are merely exemplary, and that in fact many other arrangements or architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of specific structures, architectures or intermedial components. Likewise, any two components so associated can also be viewed as being “operably connected” or “operably coupled” to each other to achieve the desired functionality.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” “comprise” and variations thereof, such as, “comprises” and “comprising” are to be construed in an open, inclusive sense, that is as “including, but not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A method of fabricating an optical modulator including a semiconductor device having an optical input at a first end region for receiving a continuous wave coherent light beam having a predetermined beam profile, and a second end region opposite the first end region, a waveguide layer for transferring the light beam, an electrode connected to a radio frequency signal input and a bias potential for creating an electric field in the waveguide and optically modulating the light beam as the beam traverses the waveguide, and an optical output connected to the waveguide at the second end region for transferring the modulated light beam, comprising:
forming a sequence of layers including a bottom cladding layer, an active layer, a top cladding layer and a contact layer on a semiconductor substrate;
providing a mask over the region where a mode conversion region is to be formed;
etching the semiconductor body down into a small portion of the thickness of the active layer thereby forming a mesa structure over the active region wherein the etching technique anisotropically etches along a plane depending upon the direction of the edge of the mask with respect to the crystal direction of the semiconductor body;
re-growing the portion of the active layer, the top cladding layer and the contact layer to the uniformly planar level of the top surface of the mesa in the mode conversion region; and
forming a waveguide in the mode conversion region by etching the semiconductor substrate down to the active layer, forming a waveguide structure that spreads the beam intensity of the predetermined beam profile.

2. A method as defined in claim 1, wherein the mask is generally a parallelogram in shape, having a first and second wing-shaped projections extending at a first end portion of the parallelogram along the longer opposed sides of the parallelogram.

3. A method as defined in claim 2, wherein the first and second wing-shaped projections are different in shape.

4. A method as defined in claim 2, wherein the wing-shaped projections have an elongated first side extending substantially parallel to the longer side of the parallelogram.

5. A method as defined in claim 4, wherein the first wing-shaped projection has a second side extending orthogonally to the first side along the first end portion of the parallelogram.

6. A method as defined in claim 4, wherein the first wing-shaped projection has a third side extending at an obtuse angle to the first side along the first end position of the parallelogram.

7. A method as defined in claim 4, wherein the second wing-shaped projection has a second side extending orthogonally to the first side along the first end position of the parallelogram.

8. A method as defined in claim 7, wherein the second wing-shaped projection has a second side extending at an acute angle to the first side along the first end position of the parallelogram.

9. A method as defined in claim 7, wherein the second wing-shaped projection has a third side extending at an obtuse angle to the first side along the first end position of the parallelogram.

10. A method as defined in claim 2, wherein the mask has a third and fourth wing-shaped projections extending at a second end portion of the parallelogram along the longer opposed sides of the parallelogram.

11. A method as defined in claim 10, wherein the third and fourth wing-shaped projections are different in shape.

12. A method as defined in claim 10, wherein the first and third wing-shaped projections are at diagonally opposite corners of the parallelograms and are mirror images of one another.

13. A method as defined in claim 10, wherein the second and fourth wing-shaped projections are at diagonally opposite corners of the parallelograms and are mirror images of one another.

14. A method of fabricating a waveguide interface on a semiconductor substrate including an optical input at a first active layer at a first region of the substrate for receiving a continuous wave coherent light beam having a predetermined first beam profile, and a second active layer at a second region of the substrate directly adjacent to the first region active layer for transferring the light beam with a predetermined second beam profile different from the first beam profile, comprising:
forming a sequence of layers including a bottom cladding layer, an active layer, a top cladding layer and a contact layer on a semiconductor substrate;
providing a mask over the region where a waveguide interface is to be formed, the mask having a peripheral profile so that during subsequent etching and regrowth of the contact layer and cladding layer, the different etching profiles of such layers as a function of the crystalline structure of the layers with respect to the direction of the waveguide on both sides of the waveguide interface is compensated by the configuration of the peripheral end region of the mask;
etching the semiconductor substrate down to the active layer thereby forming a partial waveguide interface structure from the first active layer to the second active layer;
removing the mask;
re-growing the top cladding layer and the contact layer to the level of the top surface of the partial waveguide structure; and
etching the semiconductor substrate down to the active layer from the first end region to the second end region, thereby forming a waveguide interface from the first active layer to the second active layer.

15. A method as defined in claim 14, wherein the mask is generally a parallelogram in shape, having a first and second wing-shaped projections extending at a first end portion of the parallelogram along the longer opposed sides of the parallelogram.

16. A method as defined in claim 15, wherein the first and second wing-shaped projections are different in shape.

17. A method as defined in claim 15, wherein the wing-shaped projections have an elongated first side extending substantially parallel to the longer side of the parallelogram.

18. A method as defined in claim 17, wherein the first wing-shaped projection has a second side extending orthogonally to the first side along the first end portion of the parallelogram, and a third side extending at an obtuse angle to the first side along the first end position of the parallelogram; the second wing-shaped projection has a second side extending orthogonally to the first side along the first end position of the parallelogram, a second side extending at an acute angle to the first side along the first end position of the parallelogram, and a third side extending at an obtuse angle to the first side along the first end position of the parallelogram; and the mask has a third and fourth wing-shaped projections extending at a second end portion of the parallelogram along the longer opposed sides of the parallelogram.

19. A method of fabricating a waveguide on a semiconductor substrate including an optical input at a first end region for receiving a continuous wave coherent light beam having a predetermined first beam profile, and a second end region opposite the first end region active layer for transferring the light beam with a predetermined first beam profile, comprising:
forming a sequence of layers including a bottom cladding layer, an active layer, a top cladding layer and a contact layer on a semiconductor substrate;
forming a first multimode interference (MMI) device having a first end optically coupled to an input waveguide, the first MMI device configured to receive a first optical signal and split the first optical signal into a second and third optical signals each having a respective power level and supplying said second optical signal to a first output waveguide and supplying said third optical signal to a second output waveguide, said MMI device having a propagation axis at an acute angle to a propagation axis of said input waveguide;
forming a Mach-Zehnder modulator including a first modulator arm coupled to the first output waveguide to receive the second optical signal; and a second modulator arm coupled to the second output waveguide to receive the third optical signal;
forming a second MMI device having a first input coupled to said first modulator arm and a second input coupled to said second modulator arm, said second MMI device configured to combine the second and third optical signals destructively or constructively based on a refractive index change in at least one of the modulator arms and output a modulated optical signal to an output waveguide of the second MMI device.

20. A method as defined in claim 19, further comprising:
providing a mask over the region where a waveguide is to be formed, the mask having a peripheral profile so that during subsequent etching and regrowth of the contact layer and cladding layer, the different etching profiles of such layers as a function of the crystalline structure of the layers with respect to the direction of the waveguide is compensated by the configuration of the peripheral end region of the mask;
etching the semiconductor substrate down to the active layer thereby forming a partial waveguide structure;
removing the mask;
re-growing the top cladding layer and the contact layer to the level of the top surface of the partial waveguide structure; and
etching the semiconductor substrate down to the active layer from the first end region to the second end region, thereby forming a complete waveguide structure.
first and second electrodes coupled to the corresponding first and second modulator arms, each of said electrodes configured to change a refractive index in said modulator arms in response to an applied electric field.
